(19) United States
(12) Patent Application Publication
(10) Pub. No.: US 2010/0232520 A1
(43) Pub. Date: Sep. 16, 2010

(54) SCALABLE VIDEO CODING METHOD FOR FAST CHANNEL CHANGE AND INCREASED ERROR RELILIENCE

(76) Inventors: Zhenyu Wu, Plainsboro, NJ (US); Alan Jay Stein, Princeton Junction, NJ (US); David Brian Anderson, Florence, NJ (US)

Correspondence Address: Robert D. Shedd, Patent Operations;THOMSON Licensing LLC, P.O. Box 5312, Princeton, NJ, 08543-5312, US

(21) Appl. No.: 12/734,279

(22) PCT Filed: Oct. 30, 2008
(86) PCT No.: PCT/US2008/012303

§ 371 Date: Apr. 22, 2010

Related U.S. Application Data
(60) Provisional application No. 61/001,822, filed on Nov. 5, 2007.

(51) Int. Cl. H04N 7/26

(52) U.S. Cl. 375/240.26; 375/E07.078

(57) ABSTRACT

An apparatus encodes a video signal for providing a scalable video coded (SVC) signal comprising a base layer video coded signal and an enhancement layer video coded signal, wherein the base layer video coded signal has more random access points than the enhancement layer video coded signal.

### CROSS-REFERENCE TO RELATED APPLICATIONS

This application claims the benefit of U.S. Provisional Application No. 61/001,822, filed Nov. 5, 2007.

### BACKGROUND OF THE INVENTION

The present invention generally relates to communications systems, e.g., wired and wireless systems such as terrestrial broadcast, cellular, Wireless-Fidelity (Wi-Fi), satellite, etc.

When a compressed video bit stream is delivered through an error-prone communication channel, such as a wireless network, certain parts of the bit stream may be corrupted or lost. When such erroneous bit streams reach the receiver and are decoded by a video decoder, the playback quality can be severely impacted. Source error resiliency coding is a technique used to address the problem.

In a video broadcast/multicast system, one compressed video bit stream is usually delivered to a group of users simultaneously in a designated time period often called a session. Due to the predictive nature of video coding, random access to a bit stream is only available at certain random access points inside the bit stream, so that correct decoding is only possible starting from these random access points. Since random access points generally have lower compression efficiency, there are only a limited number of such points within a bit stream. As a result, when a user tunes his receiver to a channel and joins in a session, he has to wait for the next available random access point in the received bit stream in order to have correct decoding started, which causes a delay in playback of video content. Such a delay is called tune-in delay, and it is an important factor that affects user experience of the system.

In a video delivery system, several compressed video bit streams are often delivered to the end users sharing a common transmission medium, where each video bit stream corresponds to a program channel. Similar to the previous case, when a user switches from one channel to another, he has to wait for the next available random access point in the received bit stream from the channel, in order to start decoding correctly. Such a delay is called channel-change delay, and is another important factor affecting user experience in such systems.

An advantage of inserted random access points is to improve error resiliency of a compressed video bit stream from a video coding point of view. For example, a random access point that is inserted into a bit stream periodically resets the decoder and completely stop error propagation, which improves the robustness of the bit stream against errors.

For example, consider the H.264/AVC video compression standard (e.g., see, ITU-T Recommendation H.264: “Advanced video coding for generic audiovisual services”, ISO/IEC 14496-10 (2005): “Information Technology—Coding of audio-visual objects Part 10: Advanced Video Coding”), random access points (also referred to as switching enabling points) can be implemented by coding methods including IDR (Instantaneous Decoder Refresh) slices, intra-coded macro blocks (MBs) and SI (switching I) slices.

With respect to an IDR slice, the IDR slice contains only intra-coded MBs, which does not depend on any previous slice for correct decoding. An IDR slice also resets the decoding picture buffer at the decoder so that the decoding of following slices is independent of any slice before the IDR slice. Since correct decoding is immediately available after an IDR slice, it is also called an instantaneous random access point. By contrast, gradual random access operation can be realized based on intra-coded MBs. For a number of consecutive predictive pictures, intra-coded MBs are methodically encoded so that after decoding these pictures, each MB in the following picture has an intra-coded co-located counterpart in one of pictures. Therefore, the decoding of the picture does not depend on any other slice before the set of pictures. Similarly, SI slices enable switching between different bit streams by embedding this type of specially encoded slices into a bit stream. Unfortunately, in H.264/AVC, a common disadvantage of the IDR slice or the SI slice is the loss of coding efficiency. Commonly, a significant amount of bit rate overhead has to be paid for embedding switching points.

Similarly, random access points are also used in Scalable Video Coding (SVC). In SVC a dependency representation may consist of a number of layer representations, and an access unit consists of all the dependency representations corresponding to one frame number (e.g., see Y-K. Wang, M. Hannuksela, S. Pateux, A. Eleftheriadis, and S. Wenger, “System and transport interface of SVC”, IEEE Trans. Circuits and Systems for Video Technology, vol. 17, no. 9, September 2007, pp. 1149-1163; and H. Schwarz, D. Marpe and T. Wiegand, “Overview of the scalable video coding extension of the H.264/AVC standard”, IEEE Trans. Circuits and Systems for Video Technology, vol. 17, no. 9, September 2007, pp. 1103-1120).

A common method for SVC to embed a random access point is to code an access unit entirely using IDR slices. In other words, all the layer representations in each dependency representation (D) of an access unit are coded in IDR slices. An example is shown in FIG. 1. The SVC coded signal of FIG. 1 has two dependency representations, and each dependency representation has one layer representation. In particular, the base layer is associated with D=0 and an enhancement layer is associated with D=1 (the value of “D” also referred to in the art as a “dependency_id”). FIG. 1 illustrates nine access units, which occur in frames of the SVC signal. As illustrated by dashed box 10, access unit 1 comprises an IDR slice for the first layer (D=1) and an IDR slice for the base layer (D=0). The following access unit, comprises two predicted (P) slices. It can be observed from FIG. 1 that access units 1, 5 and 9 only comprise IDR slices. As such, random access can occur at these access units. However, like H.264/AVC case, each access unit encoded with IDR slices decreases SVC coding efficiency.

### SUMMARY OF THE INVENTION

In accordance with the principles of the invention, a method for transmitting a video signal comprises scalable video coding a signal for providing a video coded signal comprising a plurality of scalable layers, wherein one of the scalable layers is chosen to have more random access points than the other scalable layers; and transmitting the scalable video coded signal. As a result, a video encoder can reduce tune-in delay and channel-change delay in a receiver by embedding additional switching enabling points within a compressed video bit stream.

In an illustrative embodiment of the invention, the SVC signal comprises a base layer and an enhancement layer and the base layer is chosen as having more random access points than the enhancement layer.

In view of the above, and as will be apparent from reading the detailed description, other embodiments and features are also possible and fall within the principles of the invention.

### BRIEF DESCRIPTION OF THE DRAWINGS

FIG. 1 shows a prior art scalable video coded (SVC) signal having Instantaneous Decoder Refresh (IDR) slices;

FIG. 2 shows an illustrative flow chart in accordance with the principles of the invention for use in SVC encoding;

FIG. 3 shows an illustrative embodiment of an apparatus in accordance with the principles of the invention;

FIG. 4 shows an illustrative SVC signal in accordance with the principles of the invention;

FIG. 5 shows another illustrative flow chart in accordance with the principles of the invention; and

FIG. 6 shows another illustrative apparatus in accordance with the principles of the invention.

### DETAILED DESCRIPTION

Other than the inventive concept, the elements shown in the figures are well known and will not be described in detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC), Chinese Digital Television System (GB) 20600-2006 and DVB-H is assumed. Likewise, other than the inventive concept, other transmission concepts such as eight-level vestigial sideband (8-VSB), Quadrature Amplitude Modulation (QAM), and receiver components such as a radio-frequency (RF) front-end (such as a low noise block, tuners, down converters, etc.), demodulators, correlators, leak integrators and squarers is assumed. Further, other than the inventive concept, familiarity with protocols such as the File Delivery over Unidirectional Transport (FLUTE) protocol, Asynchronous Layered Coding (ALC) protocol, Internet protocol (IP) and Internet Protocol Encapsulator (IPE), is assumed and not described herein. Similarly, other than the inventive concept, formatting and encoding methods (such as Moving Picture Expert Group (MPEG)-2 Systems Standard (ISO/IEC 13818-1), and the above-mentioned SVC) for generating transport bit streams are well-known and not described herein. It should also be noted that the inventive concept may be implemented using conventional programming techniques, which, as such, will not be described herein. Finally, like-numbers on the figures represent similar elements.

As noted earlier, when a receiver initially turns on, or even during a channel change or even if just changing services within the same channel, the receiver may have to additionally wait for the required initialization data before being able to process any received data. As a result, the user has to wait an additional amount of time before being able to access a service or program.

In SVC, an SVC signal has a number of dependency (spatial) layers, where each dependency layer consists of one, or more, scalable layers of the SVC signal with the same dependency_id value. The base layer represents a minimum level of resolution for the video signal. Other layers represent increasing layers of resolution for the video signal. For example, if an SVC signal comprises three layers, there is a base layer, a layer 1 and a layer 2. Each layer is associated with a different dependency_id value. A receiver can process just (a) the base layer, (b) the base layer and layer 1 or (c) the base layer, layer 1 and layer 2. For example, the SVC signal can be received by a device that only supports the resolution of the base signal and, as such, this type of device can simply ignore the other two layers of the received SVC signal. Conversely, for a device that supports the highest resolution, then this type of device can process all three layers of the received SVC signal.

In SVC, the encoding of an IDR picture is done independently for each layer. As such, and in accordance with the principles of the invention, a method for transmitting a video signal comprises scalable video coding a signal for providing a video coded signal comprising a plurality of scalable layers, wherein one of the scalable layers is chosen to have more random access points than the other scalable layers; and transmitting the scalable video coded signal. Thus, when more IDR slices are coded in a targeted dependency layer, a video encoder can reduce tune-in delay and channel-change delay in a receiver.

In an illustrative embodiment of the invention, the SVC signal comprises a base layer and an enhancement layer and the base layer is chosen as having more random access points than the enhancement layer. Although the inventive concept is illustrated in the context of selecting the base layer as having more random access point, the inventive concept is not so limited and another scalable layer can be selected instead.

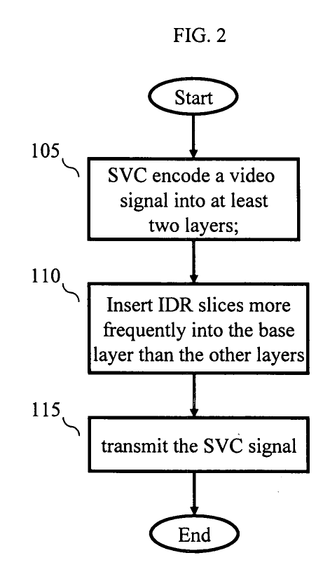

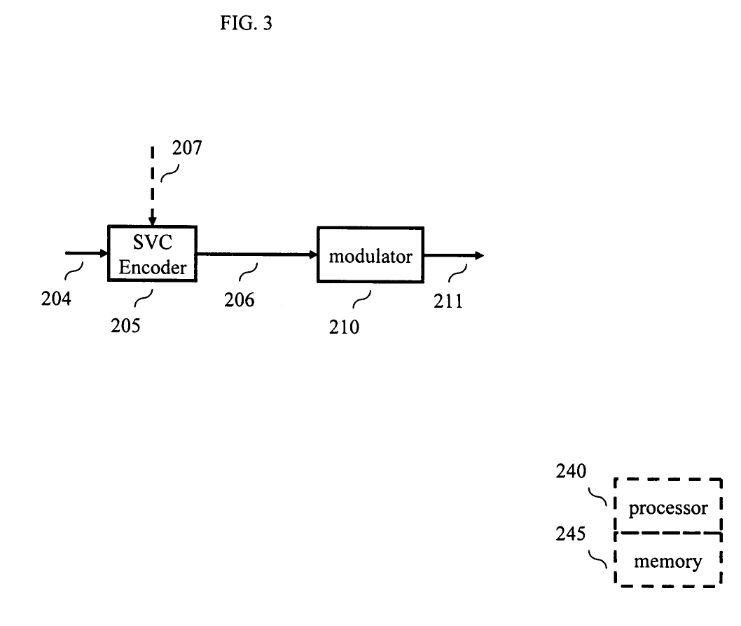

An illustrative flow chart in accordance with the principles of the invention is shown in FIG. 2. Attention should also briefly be directed to FIG. 3, which illustrates an illustrative apparatus 200 for encoding a video signal in accordance with the principles of the invention. Only those portions relevant to the inventive concept are shown. Apparatus 200 is a processor-based system and includes one, or more, processors and associated memory as represented by processor 240 and memory 245 shown in the form of dashed boxes in FIG. 3. In this context, computer programs, or software, are stored in memory 245 for execution by processor 240 and, e.g., implement SVC encoder 205. Processor 240 is representative of one, or more, stored-program control processors and these do not have to be dedicated to the transmitter function, e.g., processor 240 may also control other functions of the transmitter. Memory 245 is representative of any storage device, e.g., random-access memory (RAM), read-only memory (ROM), etc.; may be internal and/or external to the transmitter; and is volatile and/or non-volatile as necessary.

Apparatus 200 comprises SVC encoder 205 and modulator 210. A video signal 204 is applied to SVC encoder 205. The latter encodes the video signal 204 in accordance with the principles of the invention and provides SVC signal 206 to modulator 210. Modulator 210 provides a modulated signal 211 for transmission via an upconverter and antenna (both not shown in FIG. 3).

Returning now to FIG. 2, in step 105 processor 240 of FIG. 3 encodes video signal 204 into SVC signal 206 comprising a base layer and at least one other layer. In particular, in step 110, processor 240 controls SVC encoder 205 of FIG. 3 (e.g., via signal 207 shown in dashed line form in FIG. 3) such that IDR slices are inserted more frequently into the base layer than any other layer of SVC signal 206. In particular, a coding parameter is applied to SVC encoder 205 just like specifying coding patterns IBBP or IPPP, that specifies different IDR intervals at different spatial layers. In step 115, modulator 210 of FIG. 3 transmits the SVC signal.

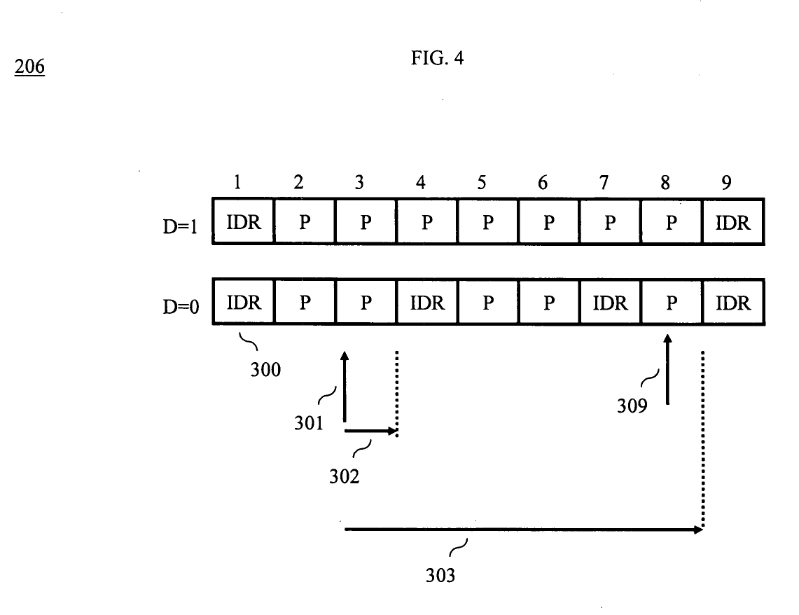

Referring now to FIG. 4, an illustrative SVC signal 206 formed by SVC encoder 205 of FIG. 3 in accordance with the flow chart of FIG. 2 is shown. In this example, SVC signal 206 comprises two layers, a base layer (D=0) and an enhancement layer (D=1). As can be observed from FIG. 4, the base layer has IDR slices in access units 1, 4, 7 and 9; while the enhancement layer only has IDR slices in access unit 1 and 9. As such, when a receiving device changes (or first tunes) to a channel that conveys SVC signal 206 at a time T_{c} as illustrated by arrow 301, the receiving device only has to wait a time T_{w} as represented by arrow 302 before being able to begin decoding the base layer of SVC signal 206 and provide a reduced resolution video picture to a user. Thus, the receiver can reduce tune-in delay and channel-change delay by immediately decoding the base layer video encoded signal, which has more random access points. As can be further observed from FIG. 4, the receiver has to wait a time T_{D} as represented by arrow 303 before being able to decode the enhancement layer and provide a higher resolution video picture to the user.

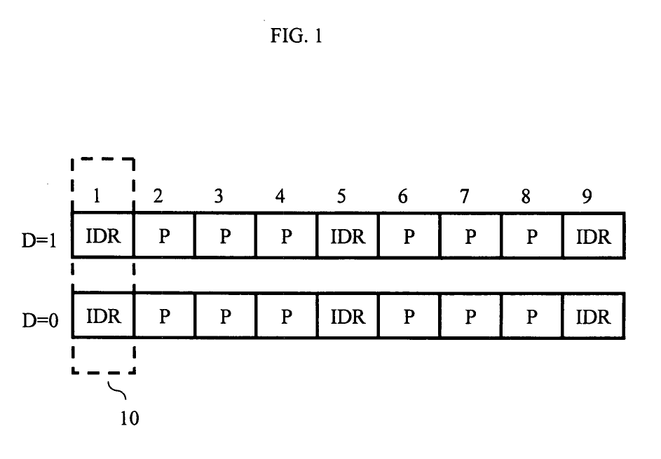

When compared to the example shown in FIG. 1, where both layers have the same IDR frequency, the inventive concept provides the ability to realize the same set of functionality improvements, but at lower bit rate with only limited performance loss. This is especially true when the base layer takes only a small portion of the total bit rate of the bit stream. For example, for a Common Intermediate Format (CIF) (372×288) resolution as the base layer (D=0) and standard definition (SD) (720×480) resolution as the enhancement layer (D=1), the base layer takes only a small percentage (e.g., around 25%) of the total bit rate. So, by increasing IDR frequency at CIF resolution, the bit rate overhead is far less compared to increasing IDR frequency at the enhancement layer only, or at both layers.

In SVC, because of the inter-layer prediction dependencies enhancement layers have on the base layer, the performance losses during the initial targeted dependency representation period can be mitigated. For example, as noted above, in FIG. 4 when channel change, or tune-in, occurs at access unit number 3, the decoder can only correctly decode the base layer bit stream until access unit number 9. However, the decoder can utilize the information contained in the corresponding enhancement layer access units to help reconstruct the video at enhancement layer quality.

It should be noted that single-loop decoding is specified in the SVC standard in order to reduce decoding complexity. To enable single-loop decoding, the encoder employs constrained inter-layer prediction so that the usage of inter-layer intra-prediction is only allowed for enhancement layer macro blocks (MBs), for which the co-located reference layer signal is intra-coded. In order to avoid reconstructing any inter-coded MBs when constructing the intra-coded MBs of the reference layer, it is further required that all layers that are used for inter-layer prediction of higher layers are coded using constrained intra-prediction.

In accordance with the principles of the invention, the increase in IDR pictures increases the number of intra-coded MBs in the base layer. When it is beneficial, the intra-coded MBs in the base layer IDR pictures can be forced to be coded with constrained intra-prediction. Consequently, the enhancement layer can have more intra-coded MBs for inter-layer intra-prediction from the base layer, which may potentially improve its coding efficiency. And with more such encoded IDR pictures at the base layer, more coding efficiency may be gained at the enhancement layer. The gain can offset the bit rate increase because of the extra IDR pictures coded at the base layer.

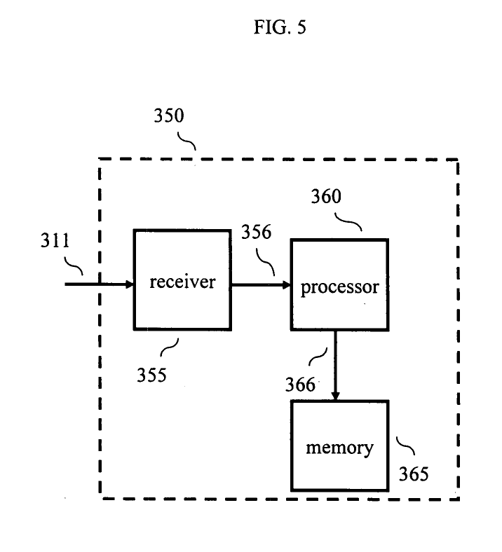

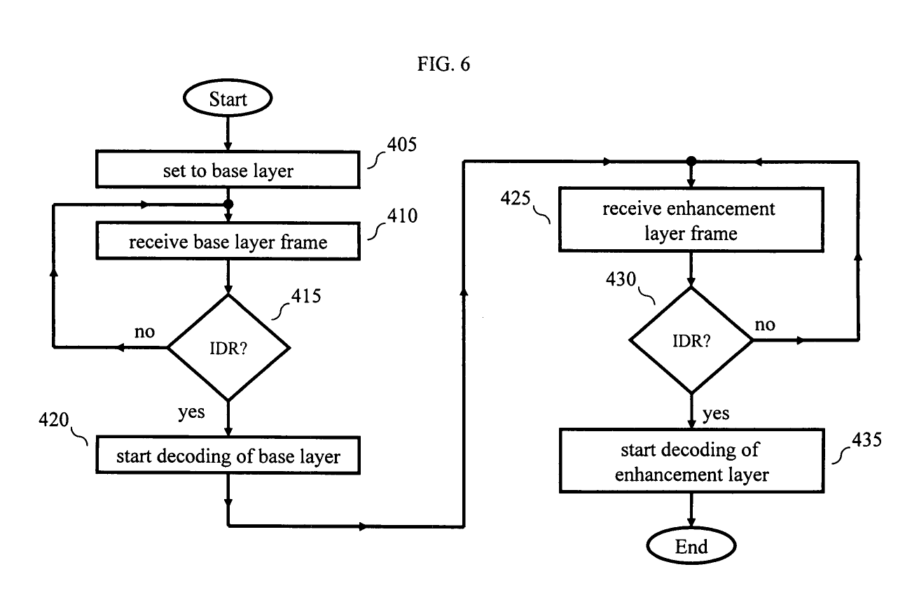

Referring now to FIG. 5, an illustrative apparatus for receiving an SVC signal in accordance with the principles of the invention is shown. Only those portions relevant to the inventive concept are shown. Apparatus 350 receives a signal conveying an SVC signal in accordance with the principles of the invention as represented by received signal 311 (e.g., this is a received version of the signal transmitted by apparatus 200 of FIG. 3). Apparatus 350 is representative of, e.g., a cellphone, mobile TV, set-top box, digital TV (DTV), etc. Apparatus 350 comprises receiver 355, processor 360 and memory 365. As such, apparatus 350 is a processor-based system. Receiver 355 represents a front-end and a demodulator for tuning into a channel that conveys an SVC signal. Receiver 355 receives signal 311 and recovers therefrom signal 356, which is processed by processor 360, i.e., processor 360 performs SVC decoding. For example, and in accordance with the flow chart shown in FIG. 6 for channel switch and channel tune-in in accordance with the principles of the invention, processor 360 provides decoded video to memory 365, via path 366. Decoded video is stored in memory 365 for application to a display (not shown) that can be a part of apparatus 350 or separate from apparatus 350.

Turning now to FIG. 6, an illustrative flow chart in accordance with the principles of the invention for use in apparatus 350 is shown. Upon switching channels or tuning into a channel, processor 360 sets decoding to an initial targeted dependency layer. In this example, this is represented by the base layer of the received SVC signal in step 405. However, the inventive concept is not so limited, and other dependency layers may be designated as the “initial targeted layer” so long as they have more random access points than the other dependency layer. In step 410, processor 360 receives a base layer frame from a received access unit (also referred to in the art as a received SVC Network Abstraction Layer (NAL) unit) and checks, in step 415, if the received base layer frame is an IDR slice. If it is not an IDR slice, then processor 360 returns to step 410 for receiving the next base layer frame. However, if the received base layer frame is an IDR slice, then processor 360 stars decoding of the SVC base layer for providing a video signal albeit at reduced resolution. Then, in step 425, processor 360 receives an enhancement layer frame from a received access unit and checks, in step 430, if the received enhancement layer frame is an IDR slice. If it is not an IDR slice, then processor 360 returns to step 425 for receiving the next enhancement layer frame. However, if the received enhancement layer frame is an IDR slice, then processor 360 stars decoding of the SVC enhancement layer in step 435 for providing a video signal at a higher resolution. In other words, upon detection of an IDR slice in a dependency layer with a value of dependency_id greater than the value of the current decoding layer, the receiver decodes the coded video in that dependency layer with the detected IDR slice. Otherwise, the receiver continues decoding the current dependency layer. It should be noted that even without an IDR from the base layer, an IDR from an enhancement layer is enough to start decoding of that enhancement layer.

It should be noted that the flow chart of FIG. 6 represents an upper layer of processing by apparatus 350. For example, once decoding of the base layer has started in step 420, this continues by processor 350 even though processor 350 also checks for the enhancement layer for IDR slices in steps 425 and 430. Likewise, even though the base layer is checked for an IDR slice in step 415 and then the enhancement layer is checked for an IDR slice in step 430, these could be from the same access unit if, e.g., a channel change, or tune-in, occurs at a time represented by arrow 309 of FIG. 4, in which case the next access unit 9 has IDR slices in both layers. Finally, although illustrated in the context of a base layer and a single enhancement layer, the flow chart of FIG. 6 is easily extendible to more than one enhancement layer.

As described above, and in accordance with the principles of the invention, a method of picture type configuration for scalable video coding is described. The inventive concept improves the error resilience for compressed bit streams generated by MPEG-SVC (e.g., see, ITU-T Recommendation H.264 Amendment 3: “Advanced video coding for generic audiovisual services: Scalable Video Coding”). Furthermore, when the aforementioned systems deliver such bit streams that are encoded in accordance with the principles of the invention, tune-in delay and channel-change delay can be reduced. It should be noted that although the inventive concept was described in the context of two-layer spatial scalable SVC bit streams, the inventive concept is not so limited and can be applied to multiple scalable layers as well as SNR (signal-to-noise ratio) scalability specified in the SVC standard.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIGS. 2 and 6, etc. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for transmitting a video signal comprising:
scalable video coding a signal for providing a video coded signal comprising a plurality of scalable layers, wherein one of the scalable layers is chosen to have more random access points than the other scalable layers; and
transmitting the scalable video coded signal.

2. The method of claim 1, wherein the chosen scalable layer is a base layer of the video coded signal.

3. A method for use in an apparatus for performing a channel change or tuning into a channel, the method comprising:
receiving a scalable video coded signal comprising a plurality of scalable layers;
setting decoding to that dependency layer having more random access points, wherein this dependency layer is the current decoding layer;
checking frames from the scalable layer having the more random access points for an Instantaneous Decoder Refresh slice;
upon detection of an Instantaneous Decoder Refresh slice in the scalable layer having the more random access points, decoding the coded video in the scalable layer having the more random access points;
checking frames from other scalable layers for an Instantaneous Decoder Refresh slice; and
upon detection of an Instantaneous Decoder Refresh slice in a dependency layer with a value of dependency_id greater than the value of the current decoding layer, decoding the coded video in that dependency layer.

4. The method of claim 3, wherein the scalable layer having the more random access points is a base layer of the scalable video coded signal.

5. Apparatus comprising:
a scalable video encoder for providing a video coded signal comprising a plurality of scalable layers, wherein one of the scalable layers is chosen to have more random access points than the other scalable layers; and
a modulator for use in transmitting the video coded signal.

6. The apparatus of claim 5, wherein the chosen scalable layer is a base layer of the video coded signal.

7. Apparatus comprising:
a receiver for providing a scalable video coded signal from a channel, the scalable video coded signal comprising a plurality of scalable layers wherein one scalable layer is chosen to have more random access points than the other scalable layers; and
a processor for decoding the scalable layer chosen to have more random access points upon changing to the channel or tuning into the channel until random access points from the other scalable layers are available.

8. The apparatus of claim 7, wherein the chosen scalable layer is a base layer of the scalable video coded signal.
